(19) United States
(12) Patent Application Publication
(10) Pub. No.: US 2004/0131976 A1
(43) Pub. Date: Jul. 8, 2004

(54) METHOD OF FORMING A THIN FILM TRANSISTOR LIQUID CRYSTAL DISPLAY

(76) Inventor: Chu-Wei Hsu, Kao-Hsiung City (TW)

Correspondence Address: NAIPO (NORTH AMERICA INTERNATIONAL PATENT OFFICE), P.O. BOX 506, MERRIFIELD, VA, 22116, US

(21) Appl. No.: 10/249,176

(22) Filed: Mar. 20, 2003

(30) Foreign Application Priority Data
Jan. 3, 2003 (TW) 092100141

(51) Int. Cl. G03C 5/00

(52) U.S. Cl. 430/311; 430/313; 430/316; 430/317; 430/320; 427/578; 427/579

(57) ABSTRACT

A gate insulating (GI) layer, an amorphous silicon layer, and a metal layer are sequentially formed on a gate formed on a substrate of a thin film transistor liquid crystal display (TFT LCD). A first photoresist layer and a second photoresist layer with an opening are then sequentially formed on the metal layer. Two etching processes are performed to form a source and a drain of the TFT LCD thereafter. Finally, a passivation layer is formed to cover the substrate.

### BACKGROUND OF INVENTION

1. Field of the Invention

The present invention relates to a method of forming a thin film transistor liquid crystal display (TFT LCD), and more specifically, to a method of forming a TFT LCD by utilizing a photoresist layer comprising a smooth top surface with a slit.

2. Description of the Prior Art

Due to continued development and advancement in electrical technology, the variety of applications as well as the demand for liquid crystal displays is ever increasing. A liquid crystal display(LCD)is one type of flat panel display and is employed extensively in applications ranging from small-scale products, such as a phygmomanometer, to various portable electronic devices such as PDAs and notebooks, and even to the commercial large panel displays. Since an LCD has the advantages of lightweight, low energy consumption, and free of radiation emission, the LCD is extensively applied to informational products and has a great potential for the future.

Generally, a thin film transistor LCD (TFT LCD) is composed of hundreds of TFTs. Please refer to FIG. 1 to FIG. 4 of schematic views of forming a TFT of a TFT LCD according to the prior art. As shown in FIG. 1, a glass substrate 10 is provided with a gate 12, comprising copper (Cu) or aluminum (Al), formed on the glass substrate 10. A gate insulating (GI) layer 14, comprising silicon oxide (SiOₓ), silicon nitride (SiN_{y}) or silicon oxynitride (SiON), an amorphous silicon layer 16, comprising a doped n⁺ layer, and a metal layer 18, comprising tungsten (W), aluminum (Al), chromium (Cr), copper (Cu), titanium (Ti), titanium nitride (TiNₓ) or Molybdenum (Mo), are then formed on the gate 12, and a two-step exposure process is performed thereafter to form a photoresist layer 20 with a slit 22 on the glass substrate 10.

As shown in FIG. 2, a first etching process is performed by using the photoresist layer 20 as a mask to remove portions of the metal layer 18 and the amorphous silicon layer 16 not covered by the first photoresist layer 20. Then, by performing a second etching process on the photoresist layer 20, portions of the photoresist layer 20 within the slit 22 are completely removed, and the thickness of the remain portions of the photoresist layer 20 is reduced as well. As shown in FIG. 3, a third etching process, using the remain portions of the photoresist layer 20 as a mask, is performed through the slit 22 thereafter to remove portions of the metal layer 18 not covered by the photoresist layer 20, forming a source 24 and a drain 26 of the TFT.

Finally, as shown in FIG. 4, the photoresist layer 20 is removed, and a passivation layer 28, comprising SiOₓ or SiN_{y}, is formed on the glass substrate 10 to cover the glass substrate 10.

The processes revealed in preceding paragraphs were revealed in the year 2000 by C. W. Kim, Y. B. Park and D. G. Kim in Samsong Industries Ltd. and Pi-Fu Chen in ERSO Inc. However, an overexposure or an underexposure phenomenon frequently occurs during the two-step exposure process performed for the formation of the photoresist layer 20 with a slit 22, causing a defective uniformity of the surface of the photoresist layer 20 as well as an abnormal width of the slit 22. As a result, a phenomenon of either over-etching or under-etching would occur during the third etching process and lead to a defective performance of the source 24 and the drain 26 due to the improper widths of the source 24 and the drain 26. The production yield rate is therefore seriously reduced.

### SUMMARY OF INVENTION

It is therefore a primary object of the present invention to provide a method of forming a thin film transistor liquid crystal display (TFT LCD) so as to prevent a defective performance of the TFT caused by a flawed uniformity of a photoresist layer as described in the prior art.

According to the claimed invention, the TFT LCD is formed on a substrate. A first metal layer is deposited on the substrate, and a first photo-etching-process (PEP) is then performed on the first meal layer to form a gate of the TFT on the substrate. A gate insulating (GI) layer, an amorphous silicon layer and a second metal layer are then sequentially formed on the gate, and a first photoresist layer is formed on the second metal layer thereafter. By forming a second photoresist layer with an opening on the first photoresist layer, portions of the first photoresist layer are exposed. A first etching process is then performed to remove portions of the second metal layer and the amorphous silicon layer not covered by the first photoresist layer, and a second etching process is performed thereafter to remove portions of the first photoresist layer and the second metal layer not covered by the second photoresist layer through the opening to form a source and a drain of the TFT. Finally, a passivation layer is formed on the substrate to cover the substrate.

It is an advantage of the present invention against the prior art that the first photoresist layer is formed on the second metal layer, and the second photoresist layer with the opening is then formed on the first photoresist layer. Therefore, the uniformity of the exposed surface of the first photoresist layer trough the opening is improved, and either an over-etching or an under-etching can be prevented during the second etching process. Consequently, the quality of the source and the drain is assured, the production yield rate of the TFT is increased as well.

These and other objectives of the present invention will no doubt become obvious to those of ordinary skill in the art after reading the following detailed description of the preferred embodiment, which is illustrated in the multiple figures and drawings.

### BRIEF DESCRIPTION OF DRAWINGS

FIG. 1 to FIG. 4 are schematic views of forming a TFT of a TFT LCD according to the prior art.

FIG. 5 are FIG. 8 of schematic views of forming a TFT of a TFT LCD according to a first embodiment of the present invention.

FIG. 9 are FIG. 12 of schematic views of forming a TFT of a TFT LCD according to a second embodiment of the present invention.

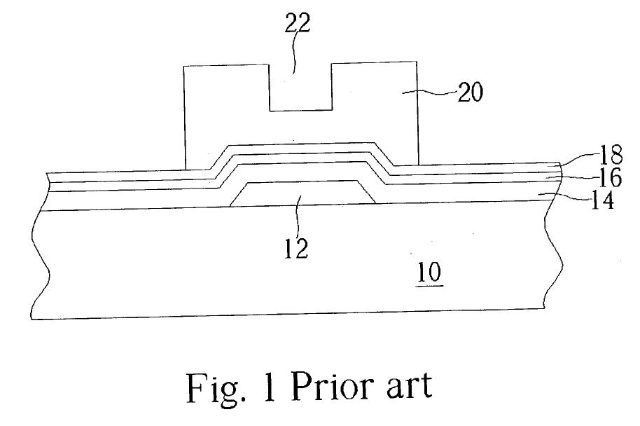

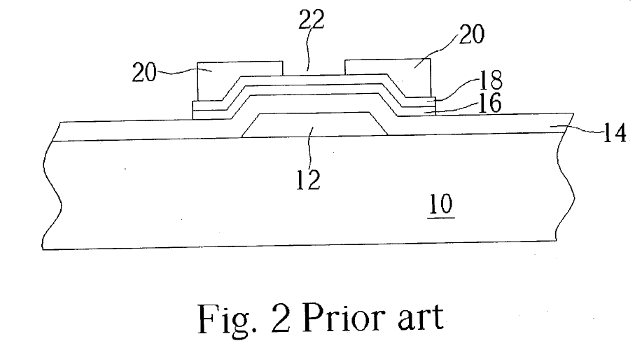

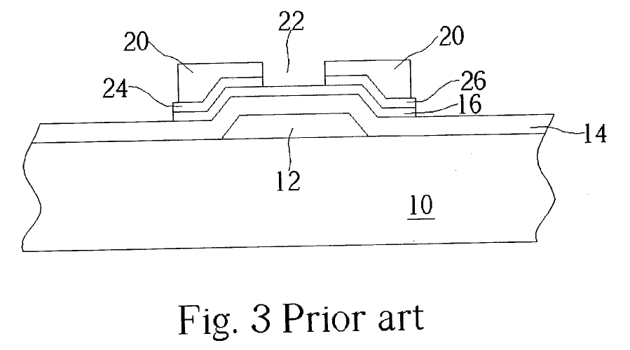

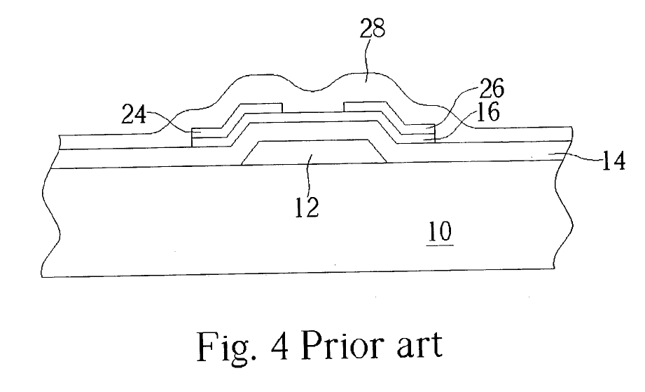

### DETAILED DESCRIPTION

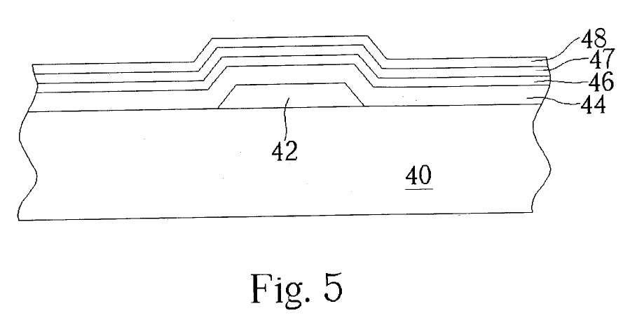

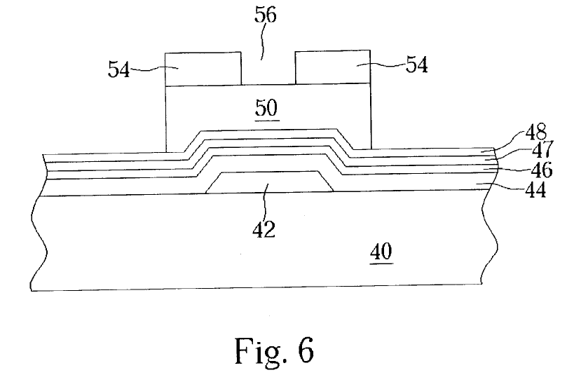

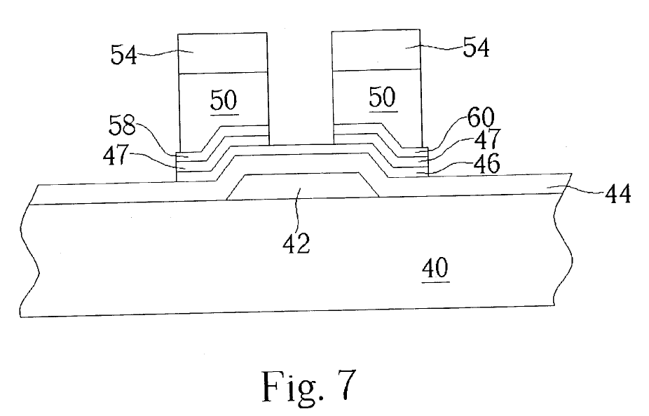

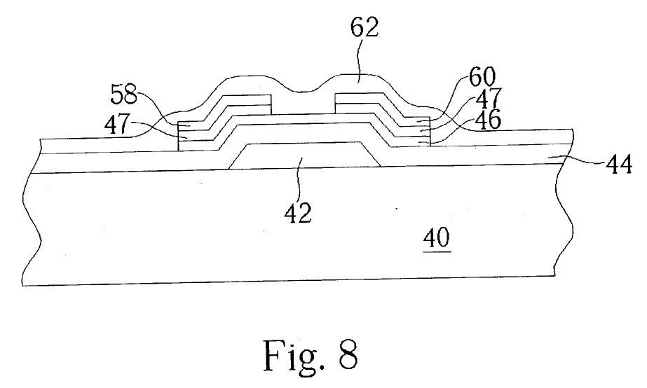

Please refer to FIG. 5 to FIG. 8 of schematic views of forming a thin film transistor (TFT) of a thin film transistor liquid crystal display (TFT LCD) according to a first embodiment of the present invention. As shown in FIG. 5, a substrate 40 is provided with a gate 42 of the TFT formed on the substrate 40. Generally, the substrate 40 comprises either one of a glass substrate, a quartz substrate or a plastic substrate, and the gate 42 comprises either one of tungsten (W), aluminum (Al), chromium (Cr), copper (Cu), titanium (Ti), titanium nitride (TiNₓ) or Molybdenum (Mo). At the beginning of the method, a plasma enhanced chemical vapor deposition (PECVD) process is performed to form a gate insulating (GI) layer 44, comprising silicon oxide (SiOₓ), silicon nitride (SiN_{y}) or silicon oxynitride (SiON), to cover the gate 42 and the substrate 40. An amorphous silicon layer 46, a doped n⁺ layer 47 and a metal layer 48 are then sequentially formed on the GI layer 44. Same as the gate 42, the metal layer 48 comprises either one of tungsten, aluminum, chromium, copper, titanium, titanium nitride or Molybdenum.

As shown in FIG. 6, a hard mask layer 50 is then formed on the metal layer 48, and a photoresist layer 54, having an opening 56 for exposing portions of the hard mask layer 50, is formed on the hard mask layer 50 thereafter. In the preferred embodiment of the present invention, the hard mask layer 50 is a negative phtoresist layer, and the photoresist layer 54 is a positive photoresist layer stacked on the hard mask layer 50 with a line width same as that of the hard mask layer 50. Alternatively, in another embodiment of the present invention, the line width of the photoresist layer 54 is larger than that of the hard mask layer 50, so that the hard mask layer 50 is surrounded by the photoresist layer 54.

As shown in FIG. 7, a first etching process is then performed to remove portions of the metal layer 48, the doped n⁺ layer 47 and the amorphous silicon layer 46 not covered by the hard mask layer 50, and a second etching process is performed through the opening 56 to remove portions of the hard mask layer 50 not covered by the photoresist layer 54 and portions of the metal layer 48 and the doped n⁺ layer 47 within the opening 56 to form a source 58 and a drain 60 of the TFT.

As shown in FIG. 8, a base PR stripper, such as an amine-containing base solution, is then employed to rinse the TFT LCD, removing the photoresit layer 54 and the hard mask layer 50. Alternatively, an ashing process is utilized for the removal of the photoresist layer 54 and the hard mask layer 50. Finally, a passivation layer 62, comprising SiOₓ or SiN_{y}, is formed to cover the substrate 40.

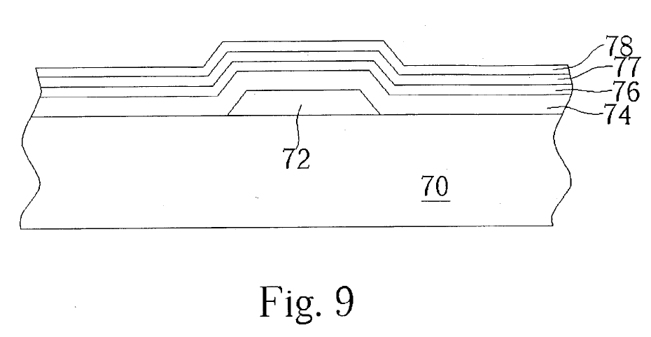

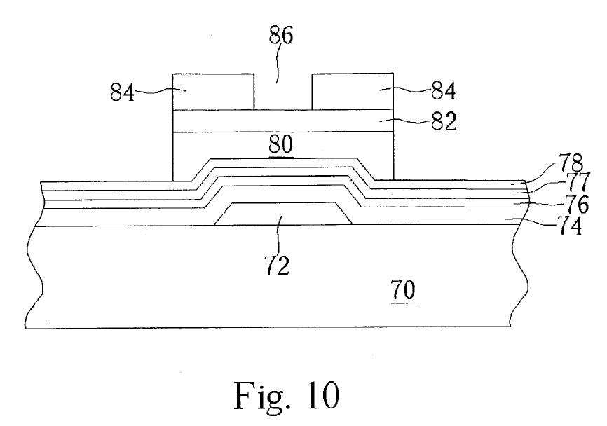

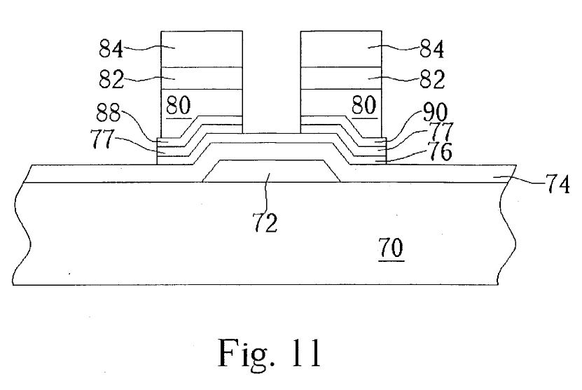

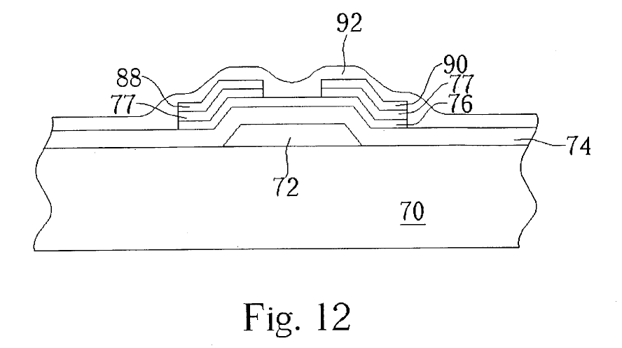

Please refer to FIG. 9 to FIG. 12 of schematic views of forming a TFT) of a TFT LCD according to a second embodiment of the present invention. As shown in FIG. 9, a substrate 70 is provided with a gate 72 of the TFT formed on the substrate 70. Same as the substrate 40 and the gate 42, the substrate 70 comprises either one of a glass substrate, a quartz substrate or a plastic substrate, and the gate 72 comprises either one of tungsten, aluminum, chromium, copper, titanium, titanium nitride or Molybdenum. At the beginning of the method, a PECVD process is performed to form a GI layer 74, comprising silicon oxide (SiOₓ), silicon nitride (SiN_{y}) or silicon oxynitride (SiON), to cover the gate 72 and the substrate 70. An amorphous silicon layer 76, a doped n⁺ layer 77 and a metal layer 78 are then sequentially formed on the GI layer 74. Same as the gate 72, the metal layer 78 comprises either one of tungsten, aluminum, chromium, copper, titanium, titanium nitride or Molybdenum.

As shown in FIG. 10, a hard mask layer 80 and an anti-reflection coating (ARC) 82 are sequentially formed on the metal layer 78, and a photoresist layer 84, having an opening 86 for exposing portions of the ARC 82, is formed on the ARC 82 thereafter. In the preferred embodiment of the present invention, the hard mask layer 80 is a thin film layer composed of a nitride layer, and the photoresist layer 84 is either a positive photoresist layer or a negative phtoresist layer.

As shown in FIG. 11, a first etching process is then performed to remove portions of the metal layer 78, the doped n⁺ layer 77 and the amorphous silicon layer 76 not covered by the hard mask layer 80, and a second etching process is performed through the opening 86 to remove portions of the ARC 82 and the hard mask layer 80 not covered by the photoresist layer 84, and portions of the metal layer 78 and the doped n⁺ layer 77 within the opening 76, so as to form a source 88 and a drain 90 of the TFT.

As shown in FIG. 12, a base PR stripper, such as an amine-containing base solution, is then employed to rinse the TFT LCD, removing the photoresit layer 84, the ARC 82 and the hard mask layer 80. Alternatively, an ashing process is utilized for the removal of the photoresist layer 84, the ARC 82 and the hard mask layer 80. Finally, a passivation layer 92, comprising SiOₓ or SiN_{y}, is formed to cover the substrate 70.

In comparison with the prior art, the method discussed in the present invention is to form the hard mask layer 50 on the metal layer 48, and then form the photoresist layer 54 with the opening 56 on the hard mask layer 50. Therefore, the uniformity of the exposed surface of the hard mask layer 50 trough the opening 56 is improved, and either an over-etching or an under-etching can be prevented during the second etching process. Consequently, the quality of the source 58 and the drain 60 is assured, the production yield rate of the TFT is increased as well.

Those skilled in the art will readily observe that numerous modifications and alterations of the device may be made while retaining the teachings of the invention. Accordingly, the above disclosure should be construed as limited only by the metes and bound of the appended claims.

What is claimed is:

1. A method of forming a thin film transistor liquid crystal display (TFT LCD) on a substrate comprising:
depositing a first metal layer on the substrate;
performing a first photo-etching-process (PEP) on the first meal layer to form a gate of the TFT on the substrate;
sequentially forming a gate insulating (GI) layer, an amorphous silicon layer and a second metal layer on the gate;
forming a first photoresist layer on the second metal layer;
forming a second photoresist layer on the first photoresist layer, the second photoresist layer comprising an opening for exposing portions of the first photoresist layer;
performing a first etching process to remove portions of the second metal layer and the amorphous silicon layer not covered by the first photoresist layer;
performing a second etching process through the opening to remove portions of the first photoresist layer not covered by the second photoresist layer and potions of the second metal layer within the opening to form a source and a drain of the TFT; and
forming a passivation layer on the substrate.

2. The method of claim 1 wherein the substrate comprising a glass substrate, a quartz substrate or a plastic substrate.

3. The method of claim 1 wherein either the first metal layer or the second metal layer comprises tungsten (W), aluminum (Al), chromium (Cr), copper (Cu), titanium (Ti), titanium nitride (TiNₓ) or Molybdenum (Mo).

4. The method of claim 1 wherein a doped n⁺ layer is further formed between the amorphous silicon layer and the second metal layer.

5. The method of claim 1 wherein the GI layer comprises silicon oxide (SiOₓ), silicon nitride (SiN_{y}) or silicon oxynitride (SiON).

6. The method of claim 5 wherein the GI layer is formed by performing a plasma enhanced chemical vapor deposition (PECVD) process.

7. The method of claim 1 wherein the first photoresist layer is a negative photoresist layer.

8. The method of claim 1 wherein the second photoresist layer is a positive photoresist layer.

9. The method of claim 1 wherein the passivation layer comprises SiOₓ or SiN_{y}.

10. A method of forming a TFT LCD on a substrate, the substrate comprising a gate formed on the substrate, the method comprising:
sequentially forming a GI layer, an amorphous silicon layer, a doped n⁺ layer and a metal layer on the gate;
forming a hard mask layer on the metal layer;
forming a photoresist layer on the hard mask layer, the photoresist layer comprising an opening for exposing portions of the hard mask layer;
performing a first etching process to remove portions of the metal layer, the doped n⁺ layer and the amorphous silicon layer not covered by the hard mask layer;
performing a second etching process through the opening to remove portions of the hard mask layer not covered by the photoresist layer and portions of the metal layer within the opening to form a source and a drain of the TFT; and
forming a passivation layer on the substrate.

11. The method of claim 10 wherein the substrate comprising a glass substrate, a quartz substrate or a plastic substrate.

12. The method of claim 10 wherein either the gate or the metal layer comprises W, Al, Cr, Cu, Ti, TiNₓ or Mo.

13. The method of claim 10 wherein the GI layer comprises SiOₓ, SiN_{y} or SiON.

14. The method of claim 13 wherein the GI layer is formed by performing a PECVD process.

15. The method of claim 10 wherein the hard mask layer and the photoresist layer are respectively a negative photoresist layer and a positive photoresist layer.

16. The method of claim 10 wherein the hard mask layer is a thin film layer.

17. The method of claim 16 wherein the thin film layer is a nitride layer.

18. The method of claim 16 wherein an anti-reflection coating (ARC) is further formed between the hard mask layer and the photoresist layer.

19. The method of claim 10 wherein the passivation layer comprises SiOₓ or SiN_{y}.
